(19) United States
(12) Patent Application Publication
(10) Pub. No.: US 2017/0301488 A1
(43) Pub. Date: Oct. 19, 2017

(54) Key Switch, Key Unit and Computer Keyboard

(71) Applicant: Wenyu ZHANG, Shenzhen (CN)

(72) Inventor: Wenyu ZHANG, Shenzhen (CN)

(21) Appl. No.: 15/463,188

(22) Filed: Mar. 20, 2017

Related U.S. Application Data
(63) Continuation-in-part of application No. PCT/CN2015/089909, filed on Sep. 17, 2015.

(30) Foreign Application Priority Data
Sep. 18, 2014 (CN) 201420538340.5
Jul. 16, 2015 (CN) 201520485646.3

(51) Int. Cl. H01H 13/7073; G06F 3/02; H01H 13/52

(52) U.S. Cl. CPC H01H 13/7073; G06F 3/02; H01H 2013/525

(57) ABSTRACT

A key switch includes an operating body, a fixing rack, a first metal spring, an elastic body and a thin film switch layer, wherein the operating body comprises a lead post, the fixing rack comprises a lead tube, the lead post is matched with the lead tube to position the elastic body, one end of the elastic body is connected with the lead post, the other opposite end of the elastic body contacts or is spaced from the surface of the thin film switch layer, and the thin film switch layer is arranged outside the fixing rack. And the present invention also provides a key unit and a computer keyboard using the same.

### FIELD OF THE DISCLOSURE

The present disclosure generally relates to input device for computer, and more particularly to key switch for keyboard, key unit for keyboard and computer keyboard using the same.

### BACKGROUND

With the development of modern electronic technology, a variety of electronic products have been developed, and as the main input device of electronic equipment, especially the keyboard of computer equipment is becoming more and more important.

The keyboard is an input device to input signal to the electronic device by pressing the corresponding key unit. Keyboards are now widely used, and the comfortable handfeel is very important.

The majority in keyboard marketing is the rubber dome type, wherein the elastic body is made of rubber and arranged between a keycap and the surface of the film switch circuit board. When a key unit is pressed, the elastic body is extruded to trigger a switch, and a corresponding film switch circuit board transmits an input signal to a central processing unit of the corresponding keyboard. The handfeel of pressing the key relies on the plastic elastic body, the force/travel curve of the plastic elastic body is wavy, as shown in FIG. 1, line1 is the force/travel curve when the key unit is pressed, and line2 is for the curve when released. The handfeel brought by such wavy curve is not good, but, such rubber dome keyboard is very popular as the cost is very low.

Another type of keyboard is called as a mechanical keyboard, in which the key switch function is realized by the metal spring and shrapnel. The force/travel curve of such mechanical key is linear, and the handfeel is excellent. However, such switch is not only expensive on the cost, but also it requires the soldering process to a rigid circuit board, which creates the difficulty for repair once any single switch broken in the keyboard. The cost is very high as well. So, the mechanical keyboard cannot be popularized so far.

Meanwhile, there is also another type a hybrid key including a metal spring and rubber dome, and the key is pressed to trigger the switch layout on the film board. The beginning of the force/travel curve is linear when only spring works, but, the curve becomes wavy after the rubber dome is pressed. So, such hybrid key still cannot provide the proper linear curve same to the mechanical key, and the corresponding keyboard is not popular.

Therefore, it is necessary to create a new type of the key with low cost and linear force/travel curve.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a force travel curve diagram of a plastic key in the prior art.

FIG. 2 is a three-dimensional exploded schematic diagram of a computer keyboard disclosed by the utility model.

FIG. 3 is a three-dimensional exploded schematic diagram of one embodiment of a key unit of the computer keyboard shown in FIG. 2.

FIG. 4 is a three-dimensional section view after a key switch shown in FIG. 3 is assembled.

FIG. 5 and FIG. 6 are partial section views of the key switch shown in FIG. 4 in disconnected and connected statues.

FIG. 7 and FIG. 8 are partial section views of a modified structure of the key switch shown in FIG. 4 in two working statues.

FIG. 9 is a three-dimensional exploded schematic diagram of the modified structure of the key switch shown in FIG. 4.

FIG. 10 is a three-dimensional section view after the key switch shown in FIG. 9 is assembled.

FIG. 11 is a force travel curve diagram of the key switch shown in FIG. 4 and FIG. 9.

FIG. 12 is a three-dimensional exploded schematic diagram of another embodiment of the key switch of the computer keyboard shown in FIG. 2, and

FIG. 13 is a three-dimensional section view after the key switch shown in FIG. 12 is assembled.

### DETAILED DESCRIPTION

The present disclosure will be described in detail below with reference to the attached drawings and exemplary embodiments thereof.

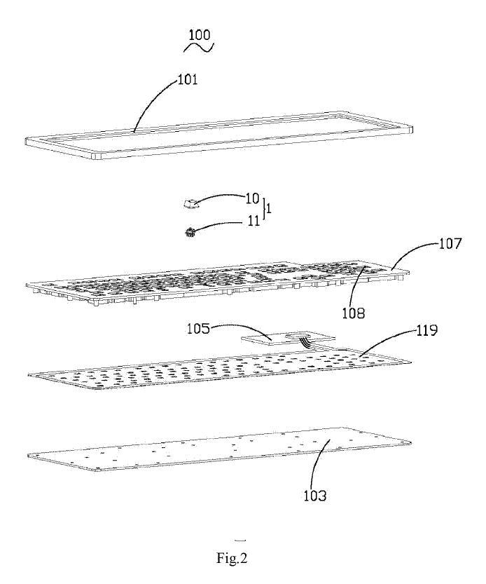

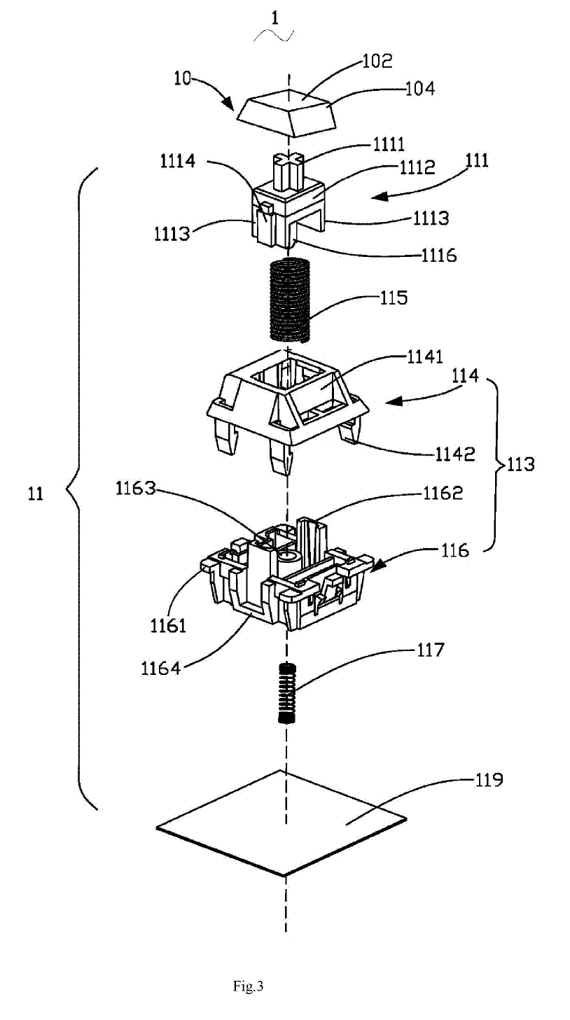

Referring to FIG. 2 and FIG. 3, a computer keyboard 100 includes an upper cover 101, a lower cover 103, a control circuit board 105, a supporting plate 107 and a plurality of key units 1. The key unit 1 includes a keycap 10 and a key switch 11. The key switch 11 includes an operating body 111, a fixing rack 113, a first metal spring 115, a second metal spring 117 and a thin film switch layer 119.

The upper cover 101 is matched with the lower cover 103 to encircle a receiving space with one end open. The control circuit board 105, the supporting plate 107 and the plurality of key units 1 are correspondingly received in the receiving space.

The key units 1 are arranged in an array manner, and the supporting plate 107 is provided with a plurality of mounting holes 108 for correspondingly nesting and fixing the plurality of key units 1. The key units 1 partially penetrate the mounting holes 108, and partially are correspondingly received in a hollow area outside the upper cover 101. The thin film switch layer 119 of the key switch 11 is sandwiched between the supporting plate 107 and the lower cover 103.

Described below are embodiments of the key unit 1 having two different structures:

### Embodiment 1

As shown in FIG. 3, a three-dimensional exploded schematic diagram discloses one embodiment of a key unit, which is showed in the computer keyboard in FIG. 2, is disclosed. The key unit 1 includes a keycap 10 and a key switch 11. The keycap 10 covers one end of the key switch 11, and moves up and down synchronously with the key switch 11.

The keycap 10 includes a top wall 102 and four side walls 104. The top wall 102 of the keycap 10 is used for user's touch and press operation. The top wall 102 is connected with the side walls 104. The four side walls 104 are connected end to end and arranged on the same side of the top wall 102, and thus the top wall 102 is matched with the four side walls 104 to encircle a receiving space with one end open. The key switch 11 abuts against the inner surface of the keycap 10.

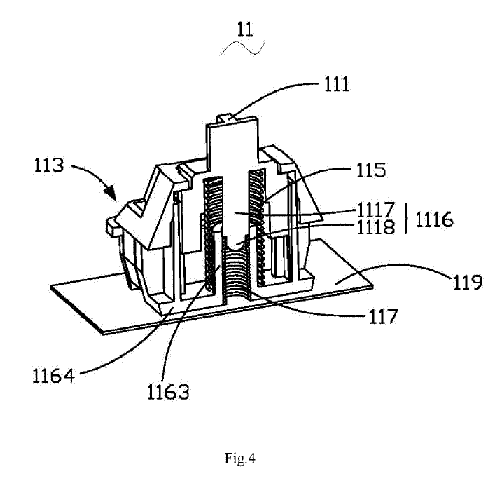

Also referring to FIG. 4, the key switch 11 is a switching element for converting a physical press input signal to an electrical signal. When a user presses the top wall 102 of the keycap 10 of the key unit 1, the key switch 11 is triggered, and the corresponding signal is transmitted to the control circuit board 105 to generate an electrical input signal. When the user releases the keycap 10 of the key unit 1, the key switch 11 becomes open, and the electrical input signal correspondingly stops.

The key switch 11 includes an operating body 111, a fixing rack 113, a first metal spring 115, a second metal spring 117 and a thin film switch layer 119. The fixing rack 113 includes a first fixing rack 114 and a second fixing rack 116, and they match with each other.

The operating body 111 includes a pressing end 1111, a body 1112, two side walls 1113, two slide bars 1114 and a guide post 1116.

The pressing end 1111 extends from the upper surface of the body 1112, and is directly nested and received inside the receiving space of the keycap 10. The whole body 1112 is cubic. The two side walls 1113 extend from the edge of the body 1112 to the side away from the pressing end 1111, and are arranged oppositely. The slide bars 1114 are strip protrusions formed on the outer surfaces of the side walls 1113. The two slide bars 1114 are in central symmetry about the body 1112. The guide post 1116 is arranged on the lower surface, away from the pressing end 111, of the body 1112, and extends from the center of the body 1112. The guide post 1116 includes a body portion 1117 and an extending end 1118 connected with each other. The extending end 1118 extends vertically from the tail end of the body portion 1117, and its cross section is smaller than that of the body portion 1117. After being assembled, the guide post 1116 contacts the first metal spring 115, and its tail end is partially inserted into a guide tube 1163. Of course, as an improvement on the above implementation, the guide post 11163 may also be of a different shape to install the first metal spring 115 together. The first fixing rack 114 of the fixing rack 113 includes four side walls 1141 and hooks 1142. The four side walls 1141 are connected end to end in sequence to encircle a hollow receiving space, and the body 1112, side walls 1113, slide bars 1114 and guide post 1116 of the operating body 111 are correspondingly received in the receiving space of the first fixing rack 114. The hooks 1142 extend from the lower surface of the first fixing rack 114 to the side away from the body 1112. There are four hooks 1142. The four hooks 1142 are arranged symmetrically.

The second fixing rack 116 is correspondingly clamped and fixed with the first fixing rack 114, and includes protrusions 1161, two chutes 1162, a guide tube 1163 and a bottom wall 1164.

The protrusions 1161 are arranged on the side walls (not marked) of the second fixing rack 116, and are correspondingly clamped and fixed with the hooks 1142 of the first fixing rack 114 together, so that the first fixing rack 114 is correspondingly clamped and assembled with the second fixing rack 116 together.

The two chutes 1162 are formed in the two opposite side walls and correspond to the slide bars 1114 of the operating body 111, the chutes 1162 are assembled with the slide bars 1114 to form a side rail and slide bar matching structure, and the slide bars 1114 can freely slide in the chutes 1162, so that the operating body 111 can freely and vertically slide back and forth relative to the second fixing rack 116 in the extending direction of the chutes 1162 within a set travel range.

The guide tube 1163 is of a hollow cylindrical structure, and penetrates the outer surface of the bottom wall 1164. Of course, as an improvement on the above implementation, the guide tube 1163 may also be of a columnar structure with discontinuous side walls, and its height is to fix second metal spring 117 in the vertical direction and the horizontal direction. Such shape change is to be counted as the same idea of the present invention.

The guide post 1116 of the operating body 111 is partially inserted into the hollow area of the guide tube 1163 of the second fixing rack 116, and can slide up and down freely relative to the second fixing rack 116. In a specific implementation, the guide post 1116 is not limited to be received in the guide tube 1163, but may also be arranged outside the guide tube 1163, i.e., the inside diameter of the guide post 1116 is greater than the outside diameter of the guide tube 1163. Or, the guide post 1116 and the guide tube 1163 are not nested with each other during assembly but correspond to each other in the vertical direction, and the guide tube 1163 is matched with the guide post 1116 to guide the first metal spring 115 to reciprocate in the vertical direction, and simultaneously to position the first metal spring 115 in the three-dimensional direction so as to avoid mutual interference between the first metal spring 115 and the second metal spring 117.

The first metal spring 115 is sleeved outside the guide tube 1163 of the fixing rack 113, with the upper end abutting against the lower surface of the body 1112 of the operating body 111, and the lower end abutting against the inner surface of the bottom wall 1164 of the second fixing rack 116. The first metal spring 115 correspondingly is deformed after being pressed by external force within an elastic deformation range, and simultaneously produces reactive elasticity. Further, the positions of the guide tube 1163 and the guide post 1116 can be changed with each other.

The second metal spring 117 correspondingly is deformed after being pressed by external force within an elastic deformation range, and simultaneously produces reactive elasticity. After being assembled, one end of the second metal spring 117 is connected with the extending end 1118 of the guide post 1116 and fixed with the body portion 1117 of the guide post 1116 by abutting, and the other opposite end of the second metal spring 117 abuts against or is spaced from the surface of the thin film switch layer 119. When the second metal spring 117 contracts after being pressed by external force, it elastically presses against the thin film switch layer 119.

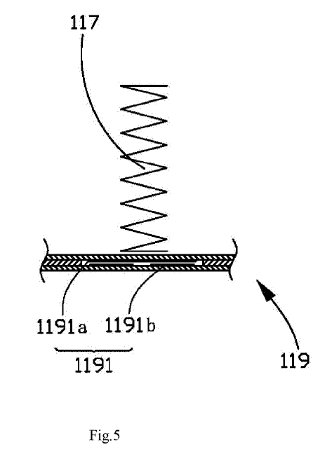

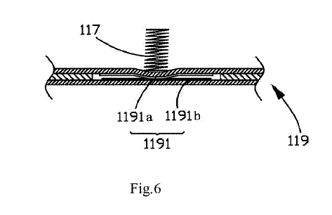

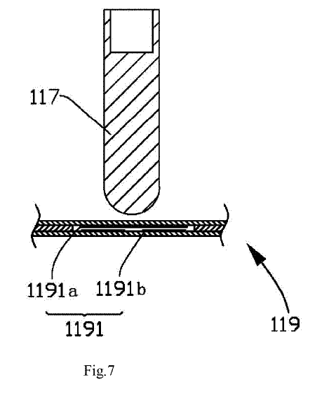

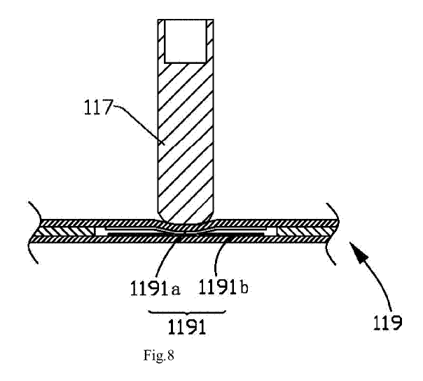

Of course, as a further improvement, the second metal spring 117 is not limited to be machined from a metal spring, but may also be of other material or structure having elasticity and providing resilience, and for those skilled in the art, all other materials or structures for forming resilience and replacing the second metal spring 117 to abut against and press the thin film switch layer 119 fulfill the creative purpose of the present invention. The second metal spring 117 or the alternative material or alternative structure thereof is continually switched between the two working statues by the abutting and spaced arrangement to the thin film switch layer 119, so as to drive the thin film switch layer 119 to be connected or opened under the action of pressure. The second metal spring 117 may be an elastic cylinder or an assembled unit for providing elastic resilience, which belongs to an equivalent structure of the present invention. In the present invention, the second metal spring 117 and its alternative structure are collectively referred to as an “elastic body”, and the specific structure is shown as FIGS. 5, 6, 7 and 8.

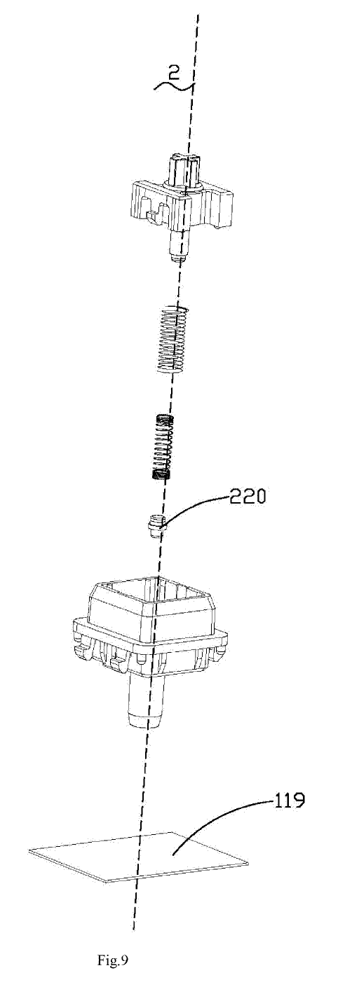

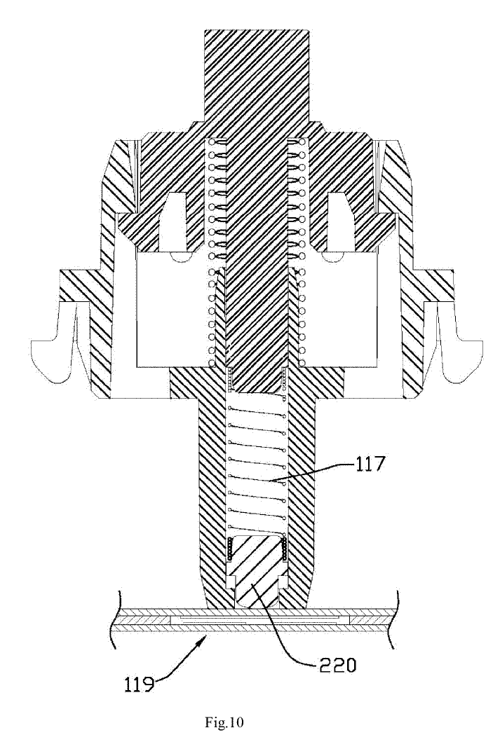

In order to further improve the tactility, a pressing body 220 is additionally arranged at the end, contacting the thin film switch layer 119, of the second metal spring 117 or its alternative material or alternative structure, and the pressing body 220 is sandwiched between the second metal spring 117 and the thin film switch layer 119. The pressing body may be made of different material from the metal spring, e.g., may be a metal shrapnel, a plastic body, a probe, etc., as shown in FIGS. 9 and 10.

The thin film switch layer 119 is a thin film layer, on whose surface a plurality of thin film switches 1191 are arranged in an array manner. The film switch layer 119 is arranged outside the second fixing rack 1116, and directly contacts or is spaced from the outer surface of the bottom wall 1164 of the second fixing rack 1116. Referring to FIGS. 5, 6, 7 and 8, the thin film switch 119 includes a first electrode 1191a and a second electrode 1191b spaced from each other, and the first electrode 1191a correspondingly contacts the second electrode 1191b under the pressure to realize connection; and when the pressure is cancelled, the first electrode 1191a is correspondingly separated from the second electrode 1191b to realize disconnection.

When the key switch 11 is assembled, firstly, the first metal spring 115 is sleeved outside the guide tube 1163 of the fixing rack 113, and the second metal spring 117 is sleeved outside the guide post 1116 of the operating body 111 in an interference manner.

Secondly, the tail end of the guide post 1116 of the operating body 111 and the second metal spring 117 are inserted into the guide tube 1163 of the second fixing rack 116, meanwhile, the slide bars 1114 are correspondingly nested and matched with the chutes 1162 of the second fixing rack 116, and because the slide bars 1114 can slide freely and vertically relative to the chutes 1162 within a set range, the operating body 111 can synchronously slide up and down relative to the chutes 1162 of the second fixing rack 116 along with the slide bars 1114 in the vertical direction.

Thirdly, the first fixing rack 114 is fixed with the second fixing rack 116 together by clamping fit between the hooks 1142 and the protrusions 1161, and correspondingly, the body 1112, side walls 1113 and slide bars 1114 of the operating body 111 are received in the hollow receiving space of the first fixing rack 114.

Finally, the thin film switch layer 119 is placed on the outer surface of the bottom wall 1164 of the second fixing rack 116.

The working principle of the key switch 11 is as follows:

Firstly, a user applies pressure to the keycap 10;

Secondly, the keycap 10 pushes the operating body 111 to move towards the thin film switch layer 119, and the distance between the both is shortened.

Specifically, the operating body 111 moves down and compresses the first metal spring 115 to drive the slide bars 1114 of the operating body 111 to slide down relatively along the chutes 1162, and, the guide post 1116 synchronously moves down and presses against the second metal spring 117, who is shortened and correspondingly creates the pressure to the thin film switch layer 119. Because of the pressure, the first electrode 1191a contacts the second electrode 1191b to realize connection of the switch, and the corresponding electrical signal is transferred to the control circuit board 105.

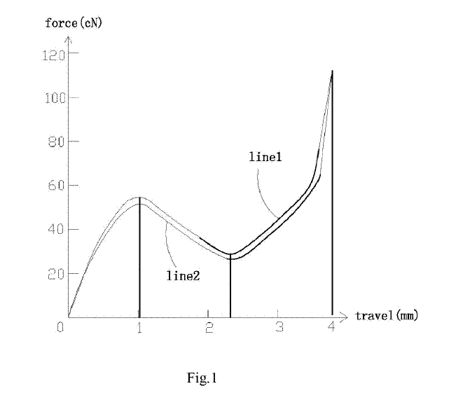

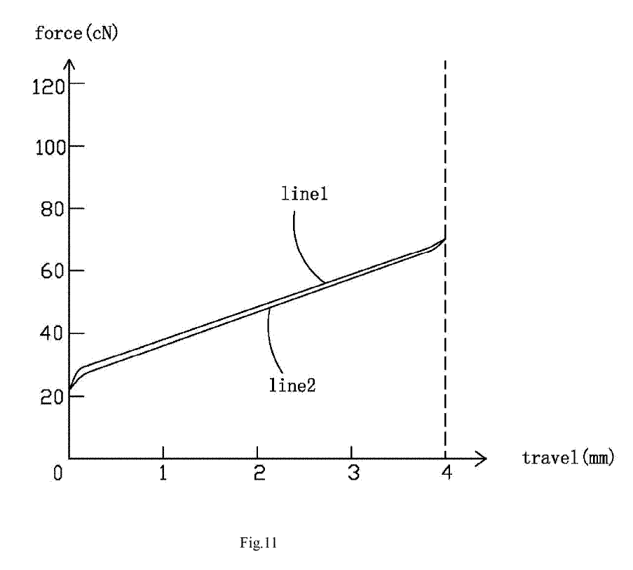

Finally, when the user releases the pressure, the first metal spring 115 produces reaction due to self deformation resilience to push the operating body 111 to move up, the guide post 1116 is driven to move up synchronously. Meanwhile, the pressure from the second metal spring 117 to the thin film switch layer 119 is gradually weakened till disappearing, and the first electrode 1191a disconnects from the second electrode 1191b, and the corresponding signal is transferred to the to the control circuit board 105. Referring to FIG. 11, a force travel curve diagram of the key switch shown in FIG. 4 and FIG. 9. The line1 is a force travel curve when the key switch 11 is pressed, line2 is a force travel curve when the key switch 11 is released, and both the line1 and the line2 are linear curves. Compared with the wavy stroke curve of the plastic key in FIG. 1, the press handfeel of the key switch 11 is excellent.

Compared with the prior art, this embodiment has the advantages that the key unit 1 is provided with the key switch 11, the first metal spring 115 is matched with the operating body 111 to transfer mechanical press, meanwhile, the second metal spring 117 elastically presses against the thin film switch layer 119 to connect or disconnect the thin film switches 1191 to make key switch 11 has two working statues. It combines the excellent handfeel of a mechanical keyboard and the low cost of a thin film switch keyboard.

### Embodiment 2

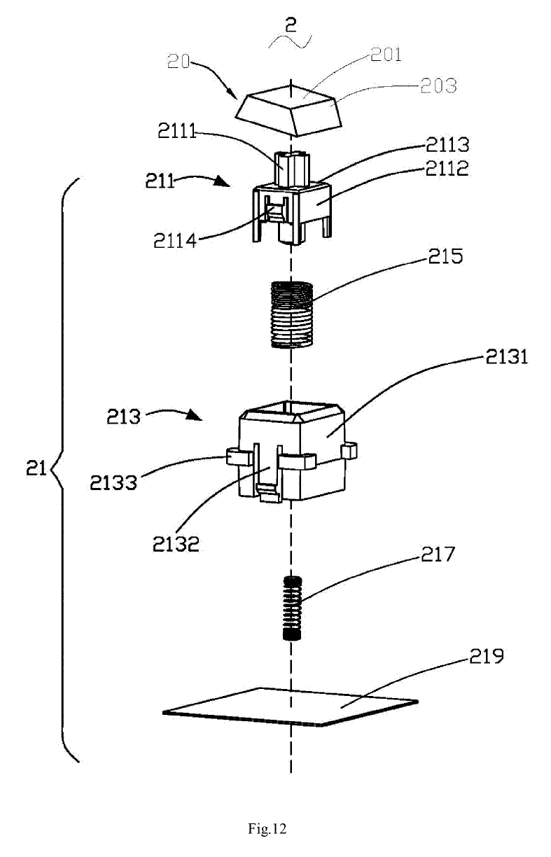

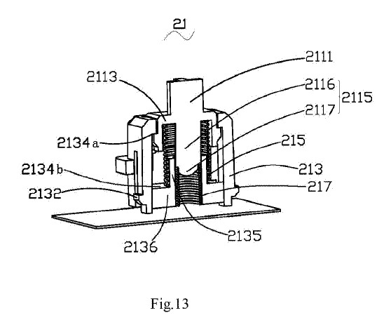

Referring to FIG. 12 and FIG. 13, wherein the FIG. 12 is a three-dimensional exploded schematic diagram of another embodiment of the key switch of the computer keyboard shown in FIG. 2, and the FIG. 13 is a three-dimensional section view after the key switch shown in FIG. 12 is assembled. The key unit 2 provided by this embodiment differs from the key unit 1 provided by embodiment 1 is that the fixing rack 213 of the key switch 21 is integrally formed.

Similarly, the key unit 2 includes a keycap 20 and a key switch 21. The keycap 20 covers one end of the key switch 21, and moves up and down synchronously with the key switch 21.

The key switch 21 of the key unit 2 is a switching element for converting a physical press input signal to an electrical signal. When a user presses the top wall 201 of the keycap 20 of the key unit 2, the key switch 21 is triggered, and the corresponding signal is transmitted to the control circuit board 105 of the computer keyboard 100 to generate an electrical input signal. When the user releases the keycap 20 of the key unit 2, the key switch 21 is closed, and the electrical input signal is stops.

The key switch 21 includes an operating body 211, a fixing rack 213, a first metal spring 215, a second metal spring 217 and a thin film switch layer 219. The working principle of embodiment 2 is same as that of embodiment 1, which is not to be redundantly described herein.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A key switch, comprising:
an operating body including a guide post;
a fixing rack including a guide tube;
a first metal spring sandwiched between the operating body and the fixing rack;
an elastic body; and
a thin film switch layer;
wherein the guide post is matched with the guide tube to position the elastic body, one end of the elastic body is connected with the guide post, the other opposite end of the elastic body contacts or is spaced from the surface of the thin film switch layer, and the thin film switch layer is arranged outside the fixing rack.

2. The key switch as described in claim 1, wherein the thin film switch layer comprises thin film switches, and the thin film switch comprises a first electrode and a second electrode spaced from each other; when the operating body is pressed, the elastic body presses against the thin film switch layer, the first electrode contacts the second electrode to realize connection; when the elastic body is released, the elastic body does not have pressure or reduces the pressure on the thin film switch layer, and the first electrode is separated from the second electrode to realize disconnection.

3. The key switch as described in claim 2, wherein the guide post comprises a body portion and an extending end connected with each other, the extending end extends vertically from the tail end of the body portion, one end of the elastic body is sleeved on the extending end and abuts against the body portion, and the other opposite end of the elastic body contacts the surface of the thin film switch layer.

4. The key switch as described in claim 2, wherein the fixing rack comprises a first fixing rack and a second fixing rack matched with each other, the first fixing rack and the second fixing rack form a receiving space, and the body and the guide post of the operating body are correspondingly received in the receiving space formed by the fixing rack.

5. The key switch as described in claim 4, wherein the operating body comprises a pressing end and a body, the pressing end and the guide post are respectively arranged on two opposite sides of the body, the pressing end is exposed outside the fixing rack, and the body and the guide post are correspondingly received in the receiving space formed by the first fixing rack and the second fixing rack.

6. The key switch as described in claim 5, wherein the operating body further comprises side walls and slide bars, the slide bars are arranged on the outer surfaces of the side walls, the first fixing rack comprises chutes, the chutes are correspondingly nested with the slide bars, and the operating body can slide back and forth relative to the first fixing rack in the extending direction of the chutes.

7. The key switch as described in claim 1, wherein the fixing rack further comprises a stop portion, and one end of the stop portion is arranged at the lower end of the inner side of the fixing rack and matched with the upper end of the fixing rack to define the maximum stroke of the operating body in the vertical direction.

8. A key switch, comprising:
an operating body including a guide post;
a fixing rack including a guide tube;
a first metal spring;
a second metal spring; and
a thin film switch layer,
wherein the guide post is partially received into the guide tube and elastically abuts against the second metal spring, the first metal spring is sleeved outside the guide tube, one end of the second metal spring elastically abuts against the guide post, the other opposite end of the second metal spring contacts or is spaced from the surface of the thin film switch layer, and the thin film switch layer is arranged outside the fixing rack.

9. A key unit, comprising:
a keycap; and
a key switch disposed under the keycap, which comprising:
an operating body including a guide post;
a fixing rack including a guide tube;
a first metal spring;
an elastic body; and
a thin film switch layer,
wherein the guide post is partially received into the guide tube and elastically abuts against the second metal spring, the first metal spring is sleeved outside the guide tube, one end of the elastic body elastically abuts against the guide post, the other opposite end of the second metal spring contacts or is spaced from the surface of the thin film switch layer, and the thin film switch layer is arranged outside the fixing rack.

10. A computer keyboard, comprising:
a plurality of key units arranged in an array manner, the key units comprising:
a keycap; and
a key switch disposed under the keycap, which comprising:
an operating body including a guide post;
a fixing rack including a guide tube;
a first metal spring;
a second metal spring; and
a thin film switch layer,
wherein the guide post is partially received into the guide tube and elastically abuts against the second metal spring, the first metal spring is sleeved outside the guide tube, one end of the second metal spring elastically abuts against the guide post, the other opposite end of the second metal spring contacts or is spaced from the surface of the thin film switch layer, and the thin film switch layer is arranged outside the fixing rack.
